(19) United States
(12) Patent Application Publication
(10) Pub. No.: US 2021/0348438 A1
(43) Pub. Date: Nov. 11, 2021

(54) IMPACT WINDOW ASSEMBLY

(71) Applicant: C.H.I. Overhead Doors, LLC, Arthur, IL (US)

(72) Inventors: Vanessa Wood, Effingham, IL (US); Michael Baker, Neoga, IL (US); Steven Smith, Mattoon, IL (US)

(21) Appl. No.: 17/315,957

(22) Filed: May 10, 2021

Related U.S. Application Data
(60) Provisional application No. 63/022,142, filed on May 8, 2020.

(51) Int. Cl. E06B 3/58; E06B 3/54; E06B 5/10

(52) U.S. Cl. CPC E06B 3/5814; E06B 2003/7044; E06B 5/10; E06B 3/5436

(57) ABSTRACT

An impact window assembly for use with an overhead door panel with an opening is disclosed. The impact window assembly includes a glazing sized to cover the opening and has an interior surface that overlap the overhead door panel about that opening. The assembly further includes a front frame having an outer edge at least slightly bigger than the opening in the overhead door panel and an inner edge smaller than the opening. The frame is vacuum-formed onto the glazing and the overhead door panel. The assembly may further include a first plurality of fasteners mechanically engaging the overhead door panel and glazing, a bead of structural sealing applied between the glazing and panel, and mounting tape between the glazing and front frame. Methods for assembling the impact window assembly are also disclosed.

### CROSS-REFERENCE TO RELATED APPLICATION

The present patent application incorporates by reference the entire provisional patent application identified by U.S. Ser. No. 63/022,142, filed on May 8, 2020, and claims priority thereto under 35 U.S.C. § 119(e).

### FIELD OF THE DISCLOSURE

The presently disclosed and/or claimed inventive concept(s) relates, in general, to an impact window assembly for an overhead garage door. More particularly the presently disclosed and/or claimed inventive concept(s) relates to a simplified, but impact strengthened window assembly capable of achieving impact rated certification.

### BACKGROUND

Efforts have been made to improve the strength of overhead garage doors in order to meet structural standards for withstanding damage, for example, in storms characterized by high winds, such as hurricanes and tornadoes. Strong winds entrain debris that may strike structures with considerable force. Impact from debris can cause a structure such as a door or window to fail, which can weaken the structure as a whole, and at least increase the likelihood of further damage by permitting wind, rain and possibly additional debris to enter the building.

As such, certain windows, doors and other similar openings (for example, those used in coastal areas) are required to be capable of surviving certain impacts—i.e., capable of achieving impact rated certification—without failing to the extent that the opening that they occupy becomes breached. Door and window structures that can routinely survive such tests are available. However, the construction of door and window structures that can achieve impact rated certification is a time-consuming procedure.

U.S. Pat. No. 3,903,669 discloses a snap-together assembly for use in mounting glass panes (36) to door frames (46). Inner and outer frames (18a and 18b, respectively) are connected together by a pin (52) that sandwiches the glass pane within the door frame by placing the pin through inner and outer frames. U.S. Pat. No. 6,711,861 discloses an impact absorbing/resistant window assembly with outer and inner frames that sandwich a transparent panel and a structural panel of a garage door. The '861 patent requires an outer frame assembly including a longitudinal channel with a T-shaped cross-section defining a longitudinal innermost portion and a narrower neck portion. The cavity is intended to slidably receive nuts when the user cooperatively positions the fastening member through the neck, securing the frames, transparent panel, and structural panel. U.S. Pat. No. 6,715,245 discloses a mounting pane structure for overhead doors which engages an impact resistant laminated glass (22) (i.e., a two or three-layer structure including a flexible plastic layer (30) preferably sandwiched between and adhered to two glass layers (27 and 28)). The '245 patent further teaches that the coupling of the flexible plastic to the structure is accomplished with either a bi-level strip (89) (a minimal structure of an elongated molding element) or an elongated molding element attached with fasteners to the structure (i.e., a garage door panel). The molding element is arranged to frame all around the glass and plastic pane body. The molding element is attachable to the door by screws or other fasteners that are extended through the molding element, through the flexible sheet and into the door, so as to capture and clamp the flexible sheet between the molding element and the door. U.S. Pat. No. 7,954,285 discloses a system including an impact glazing having a plurality of over-sized apertures around its periphery. The glazing is supported on its edges by a recess formed in the garage door panel. The system further includes a plurality of fasteners that pass through a respective aperture (leaving a circumferential gap) and screw into the edge of the garage door panel. A plurality of elastically deformable washers is placed between each fastener head and the glazing and a structural sealant (i.e., an adhesive) is applied to the inner face of the glazing around its perimeter at the apertures. The system also includes inner and outer frames secured to the garage door and glazing with adhesive tape over the fasteners.

The inventors have developed an improved and simplified, but impact-strengthened window assembly for a door. It is to such an improved window assembly and methods of producing same that the present disclosure is directed.

### SUMMARY OF THE INVENTION

The present invention is directed to an impact window assembly for use with an overhead door panel with an opening. The impact window assembly includes a glazing having an interior surface and an exterior surface, which is sized to cover the opening such that the glazing interior surface overlaps the overhead door panel about the opening. The impact window assembly further includes a front frame having an outer edge at least slightly bigger than the opening and an inner edge smaller than the opening, wherein the front frame is vacuum-formed onto the glazing and the overhead door panel. The impact window assembly may further include a first plurality of fasteners that mechanically engage the overhead door panel and glazing. The glazing may include a plurality of pilot holes about its periphery within its overlapping portion to receive one or more of the first plurality of fasteners.

In some embodiments, the impact window assembly may also include a bead of structural sealant applied on the overlapping portion of the interior surface of the glazing around a portion of its perimeter. In some embodiments, the impact window assembly may include mounting tape that is applied to the periphery of the exterior surface of the glazing such that the mounting tape is positioned between the glazing and the front frame following vacuum forming.

In certain embodiments, the impact window assembly may also include edge trim positioned over at least an interior facing side of the overhead door panel. In embodiments having an edge trim, the first plurality of fasteners may mechanically engage the overhead door panel, the glazing, and the edge trim. In other embodiments, a second plurality of fasteners mechanically engage the door panel, glazing, and edge trim, instead.

The disclosure is also directed to a method of assembling an impact window assembly for use with an overhead door panel with an opening. The method involves placing a glazing having an interior surface, an exterior surface and sized to cover the opening over the opening such that the interior surface of the glazing overlaps an exterior side of the overhead door panel about the opening; placing a front frame having an outer edge at least slightly bigger than the opening and an inner edge smaller than the opening over the exterior surface of the glazing and the exterior side of the overhead door panel; and vacuum-forming the front frame onto the glazing and the exterior side of the overhead door panel.

The method may further include securing the glazing to the overhead door panel with a first plurality of mechanical fasteners. Where such mechanical fasteners are applied, they may be secured using pilot holes formed in and about the glazing in the portion overlapping the exterior side of the overhead door panel to receive such mechanical fasteners. In some embodiments, the method may also involve applying a sealant to the periphery of the interior surface of the glazing overlapping the overhead door panel and/or applying mounting tape to the periphery of the exterior surface of the glazing prior to placing the front frame over the exterior surface of the glazing. Where mounting tape is applied, the method of assembly would further involve positioning an edge trim over an interior facing side of the overhead door panel and fastening the edge trim to the overhead door panel with the first plurality of mechanical fasteners.

### BRIEF DESCRIPTION OF THE SEVERAL VIEWS OF THE DRAWINGS

To assist those of ordinary skill in the relevant art in making and using the subject matter hereof, reference is made to the appended drawings, which are not intended to be drawn to scale, and in which like reference numerals are intended to refer to similar elements for consistency. For purposes of clarity, not every component may be labeled in every drawing. It is to be noted that the appended drawings illustrate only typical embodiments of this disclosure and are therefore not to be considered limiting in scope, for the disclosure may admit to other equally-effective embodiments. In the drawings:

FIG. 1 is a front view of an overhead door panel incorporating one embodiment of the window assembly in accordance with the present disclosure.

FIG. 2 is a front view taken from FIG. 1, showing part of the window assembly during assembly.

FIG. 3 is a cross-sectional view of an embodiment taken along line A-A of the window assembly illustrated in FIG. 1 of the present disclosure.

FIG. 4 is a detailed view of the portion of FIG. 3 within rectangle labelled A in FIG. 3.

FIG. 5 is an exemplary function flow chart of a method for assembling one embodiment of the window assembly.

FIG. 6 illustrates a cross-sectional view of another embodiment taken along line A-A of the window assembly illustrated in FIG. 1 of the present disclosure.

FIG. 7 is a detailed view of the portion of FIG. 6 within the rectangle labelled B in FIG. 6.

FIG. 8 is a cross-sectional view of yet another embodiment taken along line A-A of the window assembly illustrated in FIG. 1 of the present disclosure.

FIG. 9 is a detailed view of the portion of FIG. 8 within the rectangle labelled C in FIG. 8.

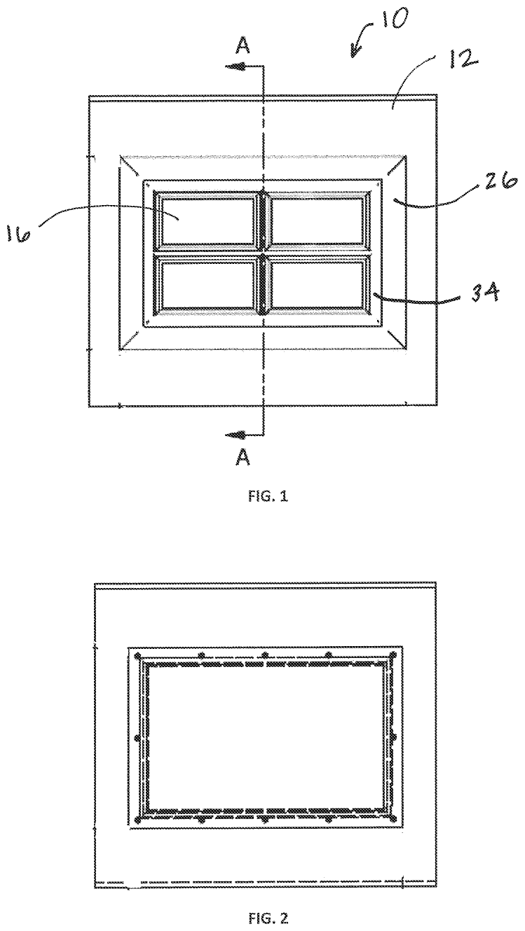

### DETAILED DESCRIPTION

Before explaining the various embodiments of the present disclosure in detail by way of exemplary language and results, it is to be understood that the present disclosure is not limited in its application to the details of construction and the arrangement of the components set forth in the following description. The present disclosure is capable of other embodiments or of being practiced or carried out in various ways. As such, the language used herein is intended to be given the broadest possible scope and meaning; and the embodiments are meant to be exemplary—not exhaustive. Also, it is to be understood that the phraseology and terminology employed herein is for the purpose of description only and should not be regarded as limiting.

Unless otherwise defined herein, mechanical and technical terms used in connection with the present disclosure shall have the meanings that are commonly understood by those of ordinary skill in the art. Further, unless otherwise required by context, singular terms shall include pluralities and plural terms shall include the singular.

As utilized in accordance with the present disclosure, the following terms, unless otherwise indicated, shall be understood to have the following meanings:

The use of the term “a” or “an” when used in conjunction with the term “comprising” in the claims and/or the specification may mean “one,” but it is also consistent with the meaning of “one or more,” “at least one,” and “one or more than one.” As such, the terms “a,” “an,” and “the” include plural referents unless the context clearly indicates otherwise. Thus, for example, reference to “a sensor” may refer to one or more sensors, two or more sensors, three or more sensors, four or more sensors, or greater numbers of sensors. The term “plurality” refers to “two or more.”

The use of the term “at least one” will be understood to include one as well as any quantity more than one, including but not limited to, 2, 3, 4, 5, 10, 15, 20, 30, 40, 50, 100, etc. The term “at least one” may extend up to 100 or 1000 or more, depending on the term to which it is attached; in addition, the quantities of 100/1000 are not to be considered limiting, as higher limits may also produce satisfactory results. In addition, the use of the term “at least one of X, Y, and Z” will be understood to include X alone, Y alone, and Z alone, as well as any combination of X, Y, and Z. The use of ordinal number terminology (i.e., “first,” “second,” “third,” “fourth,” etc.) is solely for the purpose of differentiating between two or more items and is not meant to imply any sequence or order or importance to one item over another or any order of addition, for example.

The use of the term “or” in the claims or specification is used to mean an inclusive “and/or” unless explicitly indicated to refer to alternatives only or unless the alternatives are mutually exclusive. For example, a condition “A or B” is satisfied by any of the following: A is true (or present) and B is false (or not present), A is false (or not present) and B is true (or present), and both A and B are true (or present).

As used herein, any reference to “one embodiment,” “an embodiment,” “some embodiments,” “one example,” “for example,” or “an example” means that a particular element, feature, structure, or characteristic described in connection with the embodiment is included in at least one embodiment. The appearance of the phrase “in some embodiments” or “one example” in various places in the specification is not necessarily all referring to the same embodiment, for example. Further, all references to one or more embodiments or examples are to be construed as non-limiting to the claims.

Throughout this application, the term “about” is used to indicate that a value includes the inherent variation of error for an apparatus/device/system/kit, the method being employed to determine the value, or the variation that exists among the study subjects. For example, but not by way of limitation, when the term “about” is utilized, the designated value may vary by plus or minus twenty percent, or fifteen percent, or twelve percent, or eleven percent, or ten percent, or nine percent, or eight percent, or seven percent, or six percent, or five percent, or four percent, or three percent, or two percent, or one percent or less from the specified value, as such variations are appropriate to perform the disclosed methods and as understood by persons having ordinary skill in the art.

As used in this specification and claim(s), the words “comprising” (and any form of comprising, such as “comprise” and “comprises”), “having” (and any form of having, such as “have” and “has”), “including” (and any form of including, such as “includes” and “include”), or “containing” (and any form of containing, such as “contains” and “contain”) are inclusive or open-ended and do not exclude additional, unrecited elements or method steps.

The term “or combinations thereof” as used herein refers to all permutations and combinations of the listed items preceding the term. For example, “A, B, C, or combinations thereof” is intended to include at least one of: A, B, C, AB, AC, BC, or ABC, and if order is important in a particular context, also BA, CA, CB, CBA, BCA, ACB, BAC, or CAB. Continuing with this example, expressly included are combinations that contain repeats of one or more item or term, such as BB, AAA, AAB, BBC, AAABCCCC, CBBAAA, CABABB, and so forth. The skilled artisan will understand that typically there is no limit on the number of items or terms in any combination, unless otherwise apparent from the context.

The use of ordinal number terminology (i.e., “first”, “second”, “third”, “fourth”, etc.) is solely for the purpose of differentiating between two or more items and, unless explicitly stated otherwise, is not meant to imply any sequence or order or importance to one item over another or any order of addition.

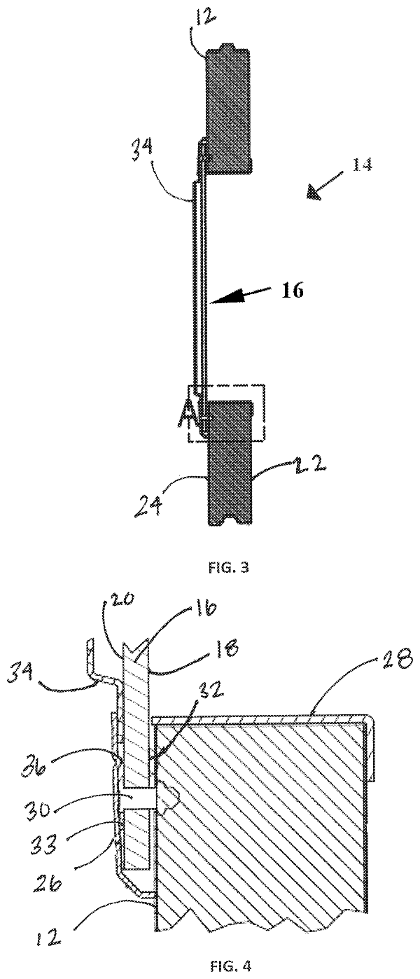

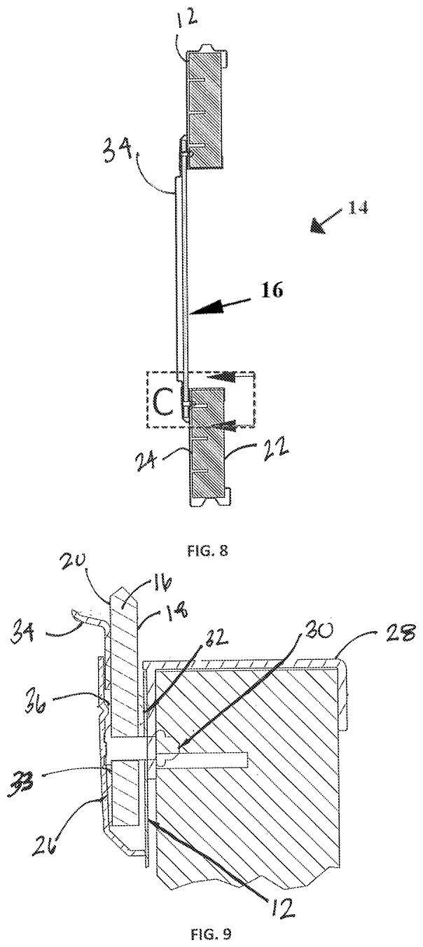

Referring now to FIG. 1, shown therein is an exemplary embodiment of an impact window assembly 10 according to the instant disclosure. Generally, the impact window assembly 10 is assembled about an overhead door panel 12, such that the panel may be considered as part of the assembly 10. Otherwise, impact window assembly 10 includes a glazing 16, a vacuum-formed front frame 26, and a vacuum-formed window insert 34. The impact window assembly 10 is shown mounted in conjunction with an overhead door panel such as a sectional overhead door, generally indicated by the numeral 12, of a type, for instance, employed in garages for homes. It will be appreciated, however, that the impact window assembly 10 can readily be adapted for use in a wide variety of residential and commercial barriers used in building openings. It will also be appreciated that the glazing system could be used with a one-piece overhead door or a sectional door. In certain non-limiting embodiments, the door panel 12 may be supported and moved in any number of ways known in the art. The door panel 12 may comprise an insulated door panel or uninsulated door panel as known in the art. Polystyrene insulated door panels are depicted in FIGS. 3, 4, 8, and 9.

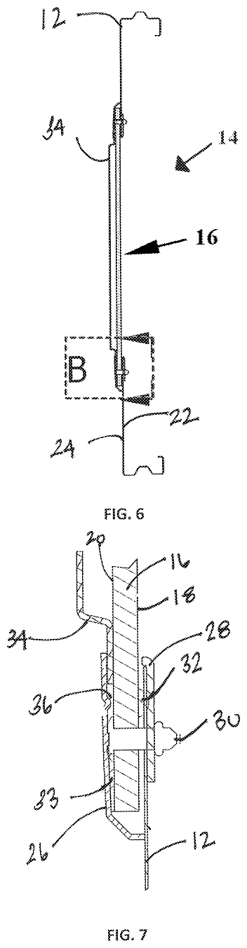

One or more impact window assembly(ies) 10 are mounted in one or more opening(s) 14 (see, e.g., FIGS. 3, 6, and 8) within door panel 12. Although exemplary embodiments are shown in the Figures in which one impact window assembly 10 is mounted in door panel 12, window assemblies 10 may be mounted in openings in any amount, spacing, and/or configuration. In certain non-limiting embodiments, panels of the overhead door not having glazing systems disposed therein may include raised embossments as is known in the art.

The impact window assembly 10 includes a glazing 16 is positioned over the opening 14 in door panel 12. The glazing 16 may be, but is not limited to, a polycarbonate glazing, such as a polycarbonate sheet. In certain non-limiting embodiments, the glazing 16 may be a 0.25-inch-thick polycarbonate sheet, or greater than 0.25-inch-thick polycarbonate sheet.

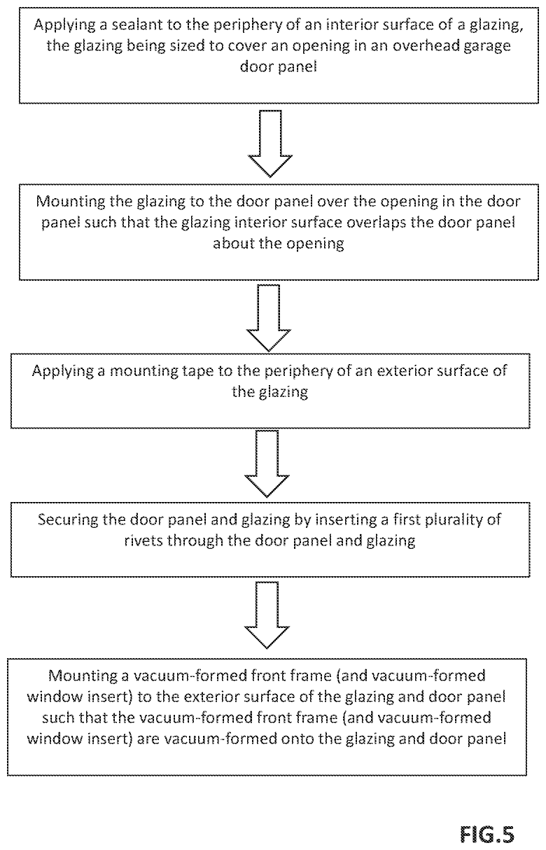

The glazing 16 may be slightly larger than the opening 14 in door panel 12, such that glazing 16 is supported (as shown, for instance, in FIGS. 3 and 4) on its edges by the door panel 12 so that a planar interior surface 18 of the glazing 16 sits substantially flush with the facing exterior side 24 of door panel 12, while covering the opening 14. In some non-limiting embodiments, all sides of glazing 16 overlap the opening 14. The amount that the glazing 16 overlaps the door panel 12 on each side may comprise a range of from about 0.5 to about 2.5 inches, or from about 0.5 to about 2.0 inches, or from about 0.5 to about 1.5 inches, or from about 0.5 to about 1.25 inches, or from about 0.5 to about 1.0 inches, or from about 0.75 to about 2.5 inches, or from about 0.75 to about 2.0 inches, or from about 0.75 to about 1.5 inches, or from about 0.75 to about 1.25 inches or from about 0.75 to about 1.0 inches, or from about 0.8 to about 2.5 inches, or from about 0.8 to about 2.0 inches, or from about 0.8 to about 1.5 inches, or from about 0.8 to about 1.25 inches, or from about 0.8 to about 1.0 inches, or from about 0.9 to about 2.5 inches, or from about 0.9 to about 2.0 inches, or from about 0.9 to about 1.5 inches, or from about 0.9 to about 1.25 inches, or from about 0.9 to about 1.0 inches, or from about 1.0 to about 2.5 inches, or from about 1.5 to about 2.5 inches, or from about 2.0 to about 2.5 inches. In one non-limiting embodiment, the glazing 16 overlaps the door panel 12 by about 1.25 inches on each side. In some embodiments, the size of the overlap of the glazing 16 and the door panel 12 is substantially the same around the glazing's entire perimeter. In other non-limiting embodiments, the size of the overlap of the glazing 16 and the door panel 12 may vary on each of the four sides of the glazing 16 from each other.

The impact window assembly 10 may include a vacuum-formed front (exterior) frame 26 (the reference to exterior in this context is with reference to exterior of the space enclosed by the overhead door associated with the window assembly 10). In certain non-limiting embodiments, the vacuum-formed front frame 26 may comprise decorative and aesthetically pleasing trim. The vacuum-formed front frame 26 is positioned over the periphery of the exterior surface 20 of the glazing 16. In other words, the vacuum-formed front frame 26 is positioned over the area of overlap of the glazing 16 and the door panel 12, on the exterior surface 20 of the glazing 16 and on the exterior side 24 of the door panel 12. As shown in FIGS. 3 and 4, vacuum-formed front frame 26 may have a two-step substantially flat inner surface, such that the first step portion of the vacuum-formed front frame 26 sits against (or at least near to) both the exterior surface 20 of the glazing 16 and against the vacuum-formed window insert 34 and the second step portion of the vacuum-formed front frame 26 sits against the exterior side 24 (see FIG. 3) of door panel 12. As would be understood to a person of ordinary skill in the art to achieve this preferred result, the step between the first and second level should approximate the anticipated thickness of glazing 16 and vacuum-formed window insert 34. Of course, it would also be understood that the design and type of material used to fabricate front frame 26 will provide sufficient mechanical flexibility to accommodate varying thicknesses.

The periphery of the vacuum-formed window insert 34 is positioned between the glazing 16 and the vacuum-formed front frame 26, as shown in FIGS. 4, 7, and 9. The vacuum-formed window insert 34 may comprise a decorative window insert or insulated window insert or other insert as known in the art. In certain non-limiting embodiments, the vacuum-formed front frame 26 of an impact window assembly 10 includes a notch 36 in the vacuum-formed front frame 26 dimensioned to receive the window insert 34. In such embodiments, the vacuum-formed window insert 34 may be placed on the exterior surface 20 of the glazing 16 and is engaged between the glazing 16 and the vacuum-formed front frame 26 within the notch 36 such that the vacuum-formed window insert 34 is retained by the notch 36 relative to the glazing 16.

The vacuum-formed front frame 26 and vacuum-formed window insert 34 may be vacuum-formed about opening 14, such that the vacuum-formed front frame 26 and vacuum-formed window insert 34 are molded onto door panel 12 and glazing 16 without the use of additional fasteners. In such an impact window design, the glazing 16 takes the full impact of any wind.

The impact window assembly 10 may include edge trim 28, as shown in FIGS. 4, 7, and 9. The edge trim 28 is positioned over the interior facing side 22 of door panel 12, the exterior facing side 24 of door panel 12, the opening facing side 25 of door panel 12, or combinations thereof.

The impact window assembly 10 includes a plurality of rivets 30 that extend through the area of overlap of the glazing 16 and the door panel 12 (i.e., through both the glazing 16 and door panel 12), edge trim 28, or combinations thereof, as depicted in FIGS. 4, 7, and 9. The glazing 16 may be provided with a plurality of pilot holes about its periphery within the area of overlap (i.e., the overlapping portion) to receive a respective one of the rivets 30. These pilot holes preferably have an inner diameter sized to accommodate the outer diameter of rivet 30, and more preferably sized only slightly wider than the outer diameter of rivet 30 (as illustrated by FIGS. 4, 6 and 9).

The one or more rivet 30 may extend in door panel 12 (for example, in an insulated door panel) or through door panel 12 (for example, in an uninsulated door panel, such as illustrated in FIG. 7). In certain non-limiting embodiments, rivet 30 may be positioned in door panel 12 and may extend through glazing 16, as shown in FIG. 4. In other non-limiting embodiments, rivet 30 may be positioned to extend through edge trim 28, door panel 12, and glazing 16, as shown in FIG. 7. In other non-limiting embodiments, rivet 30 may be positioned in door panel 12 and may extend through edge trim 28 and glazing 16, as shown in FIG. 9. The one or more rivet 30 may be steel bulbing rivets and are inserted through the glazing 16 and into the door panel 12.

The rivets 30 may also optionally be inserted through edge trim 28. As such, rivets 30 should be long enough to accommodate much, if not all, of the thickness of the components of the assembly 10, but not including the thickness of vacuum-formed front frame 26 or vacuum-formed window insert 34. As shown in FIGS. 4, 7, and 9, the one or more rivet 30 does not extend through vacuum-formed front frame 26 or vacuum-formed window insert 34.

Prior to installing glazing 16 over opening 14, a sealant 32 may be applied to at least a portion of the perimeter of interior surface 18 of glazing 16 such that sealant 32 is positioned between interior surface 18 of glazing 16 and facing exterior side 24 of door panel 12 when glazing is installed over opening 14. The sealant 32 may be a hot melt sealant or any compatible adhesive. Prior to installing vacuum-formed front frame 26 over glazing 16, a mounting tape 33 may be applied to the periphery of exterior surface 20 of glazing 16, such that mounting tape 33 is positioned between exterior surface 20 of glazing 16 and the facing interior side of vacuum-formed front frame 26. The mounting tape 33 is preferably an acrylic adhesive foam tape. The foam substrate allows the tape to conform around rivet 30 and into the interior profile of vacuum-formed front frame 26. Accordingly, mounting tape 33 may be a minimum of 6.4 mm wide (but more preferably is 0.5 inches). It may alternatively have a width that approximates the distance between the outer periphery of the rivets 30 edge of glazing 16). Mounting tape 33 has a total thickness of about 0.4 mm to 2.3 mm (but most preferably 1.1 mm thick). One currently commercially available mounting tape that meets these parameters is 3M® VHB™ Tape 4951F (manufactured by 3M Company of St. Paul Minn.). The mounting tape is applied by hand to the outer surface of the glazing 16 and then rolled with a pressure roller such that a significant portion of the tape experiences a pressure of approximately 15 psi.

FIG. 5 is an exemplary function flow chart of a method for assembling one embodiment of the window assembly. In the exemplary method, assembly may begin by applying a sealant to the periphery of an interior surface of a glazing (sized to cover an opening in an overhead garage door panel). After applying the sealant, the glazing may be mounted to the door panel over the opening such that the glazing interior surface overlaps the door panel about the opening. In the exemplary method, mounting tape is applied to the periphery of an exterior surface of the glazing. This step may take place after mounting the glazing to the door the panel, but could also take place even before applying the sealant to the glazing or before mounting the glazing to the door panel. The glazing and door panel are secured to one another by inserting a first plurality of rivets through the door panel and the glazing. Most preferably, the rivets will be applied from the glazing side and into the door panel. The riveting step may take place before or after the mounting tape has been applied to the periphery of the exterior surface of the glazing. Last, mount a vacuum-formed front frame (and vacuum-formed window insert) to the exterior surface of the glazing and door panel such that the vacuum-formed front frame (and vacuum-formed window insert) are vacuum-formed onto the glazing and door panel.

From the above description, it is clear that the inventive concept(s) disclosed herein is well adapted to carry out the objects and to attain the advantages mentioned herein as well as those inherent in the inventive concept(s) disclosed herein. While presently preferred embodiments of the inventive concept(s) disclosed herein have been described for purposed of this disclosure, it will be understood that numerous changes may be made which will readily suggest themselves to those skilled in the art and which are accomplished within the scope and spirit of the inventive concept(s) disclosed herein.

What is claimed is:

1. An impact window assembly for use with an overhead door panel with an opening, comprising:
a glazing having an interior surface and an exterior surface, the glazing being sized to cover the opening and have the glazing interior surface overlap the overhead door panel about the opening;
a front frame having an outer edge at least slightly bigger than the opening and an inner edge smaller than the opening, wherein the front frame is vacuum-formed onto the glazing and the overhead door panel; and
a first plurality of fasteners mechanically engage the overhead door panel and glazing.

2. The impact window assembly of claim 1 wherein the glazing includes a plurality of pilot holes about its periphery within its overlapping portion to receive one or more of the first plurality of fasteners.

3. The impact window assembly of claim 2 further comprising a bead of structural sealant applied on the overlapping portion of the interior surface of the glazing around a portion of its perimeter.

4. The impact window assembly of claim 3 further comprising mounting tape applied to the periphery of the exterior surface of the glazing so as to be positioned between the glazing and the front frame following vacuum forming.

5. The impact window assembly of claim 4 further comprising an edge trim positioned over at least an interior facing side of the overhead door panel.

6. The impact window assembly of claim 5 wherein the first plurality of fasteners mechanically engage the overhead door panel, the glazing, and the edge trim.

7. The impact window assembly of claim 5 further comprising a second plurality of fasteners mechanically engage the door panel, glazing, and edge trim.

8. The impact window assembly of claim 1 further comprising a bead of structural sealant applied on the overlapping portion of the interior surface of the glazing around a portion of its perimeter.

9. the impact window assembly of claim 1 further comprising mounting tape applied to the periphery of the exterior surface of the glazing so as to be positioned between the glazing and the front frame following vacuum forming.

10. The impact window assembly of claim 1 further comprising an edge trim positioned over at least an interior facing side of the overhead door panel.

11. The impact window assembly of claim 10 wherein the first plurality of fasteners mechanically engage the overhead door panel, the glazing, and the edge trim.

12. The impact window assembly of claim 10 further comprising a second plurality of fasteners mechanically engage the overhead door panel, the glazing, and edge trim.

13. A method of assembling an impact window assembly for use with an overhead door panel with an opening, comprising:
placing a glazing having an interior surface, an exterior surface and sized to cover the opening over the opening such that the interior surface of the glazing overlaps an exterior side of the overhead door panel about the opening;
placing a front frame having an outer edge at least slightly bigger than the opening and an inner edge smaller than the opening over the exterior surface of the glazing and the exterior side of the overhead door panel; and
vacuum-forming the front frame onto the glazing and the exterior side of the overhead door panel.

14. The method of assembling an impact window assembly of claim 13 further comprising securing the glazing to the overhead door panel with a first plurality of mechanical fasteners.

15. The method of assembling an impact window assembly of claim 14 further comprising using pilot holes formed in and about the glazing in the portion overlapping the exterior side of the overhead door panel to receive at least a portion of the first plurality of mechanical fasteners.

16. The method of assembling an impact window assembly of claim 15 further comprising applying a sealant to the periphery of the interior surface of the glazing overlapping the overhead door panel.

17. The method of assembling an impact window assembly of claim 16 further comprising applying mounting tape to the periphery of the exterior surface of the glazing prior to placing the front frame over the exterior surface of the glazing.

18. The method of assembling an impact window assembly of claim 17 further comprising positioning an edge trim over an interior facing side of the overhead door panel and fastening the edge trim to the overhead door panel with the first plurality of mechanical fasteners.
